(19) United States
(12) Patent Application Publication
(10) Pub. No.: US 2004/0103064 A1
(43) Pub. Date: May 27, 2004

(54) Models for marketing and selling access to on-line content

(76) Inventors: Thomas Howard, Media, PA (US); Steven Landau, Voorhees, NJ (US); John J. Rosinski, Fair Haven, NJ (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/304,722

(22) Filed: Nov. 26, 2002

(51) Int. Cl. G06F 17/60

(52) U.S. Cl. 705/55

(57) ABSTRACT

Several commercial models relating to the payment for online content are disclosed herein. In lieu of prior art username/password combinations to gain access to exclusive on-line content, a tangible asset, namely a smart card, is used. Access is automatically granted when the smart card is inserted into a reader attached to the user's PC, and cut off when the smart card is removed from the reader. In this new model, the smart card provides a tangible, saleable, value-carrying asset that can be retailed, or otherwise distributed, which grants access to exclusive on-line content.

### FIELD OF THE INVENTION

This invention relates to the delivery of, access to and payment for content which is delivered on-line and, in particular, which is delivered via the Internet.

### BACKGROUND OF THE INVENTION

This invention is related to the use of smart cards for the purpose of gaining access to various content available online. Payment for online content is well known in the prior art. It is common for services or exclusive content to be delivered over the Internet for some form of payment. For example, many newspapers or magazines will allow access to exclusive content-bearing sites in exchange for the payment of a fee. Likewise, it is also possible to pay for and download digital products, for example music and software, from the Internet. An example of a for-fee online service is software support.

All of the currently known forms of content and service delivery online in exchange for the payment of a fee have one thing in common, that is, the granting of access to the services, product or content is typically enabled via a username and/or password combination. Thus, when payment is rendered, the user is provided with a username and/or password which is used to access the service, content or product online.

Likewise, the use of smart cards for certain applications is also well known in the prior art. Currently, there are prior art examples of the use of smart cards as vehicles for the payment of online services. For example, American Express and Visa are currently utilizing smart cards with certain merchants whereby payment is rendered to the merchant from the user by inserting a smart card into a special reader attached to the user's PC. The card is authenticated by an authentication server at the site owned by the credit card company and a data packet is sent to the user, which is then forwarded to the merchant as a form of payment. The merchant then forwards the data pack to the credit card provider in exchange for the transfer of funds from the credit card company to the merchant. This obviates the need for the user to type in the actual credit card account number and also helps prevent fraud because the credit card number is not transmitted to the merchant from the user over the Internet.

Additionally, certain smart cards are in use that provide assistance in on-line game playing. For example, a player can log onto a site and play a game, and the results or points are transmitted back to the user's personal computer (PC) and stored on a smart card. Likewise, a user could pause an online game and the current state of the game could be saved on the user's smart card, such that the user could restart the game at some future time.

Lastly, U.S. Pat. No. 5,995,695 (Experton) assigned to Humetrix, Inc. of San Diego, Calif., outlines a method whereby a smart card is inserted into a reader which causes an automatic launching of an Internet browser and provides on-line access to data associated with the user. That patent is hereby incorporated by reference. The main purpose of the Experton patent is for access to medical records online.

### SUMMARY OF THE INVENTION

The on-line content delivery and smart card technologies outlined herein have been combined into a new business model for revenue generation through the selling of access via smart cards. Disclosed herein, using several exemplary models, is a method wherein a smart card is sold as a tangible asset which grants access to intangible, and preferably exclusive, online content. Several models are presented as embodiments of the invention.

In the first model, the user purchases a smart card which, when inserted into a smart card reader, grants the user access to an exclusive site on the Internet not available to the general public. At the site is static content. An example of such a card would be the sale of the smart card in lieu of a compact disc, whereby the user inserts the card into the reader to gain access to a site containing music files from an artist's newly released album. Another example of use under this model would be as a key to access exclusive content on a celebrity's website, for example, videos, photographs, sound bytes, etc., that would not otherwise be available to the general public.

In a second model, the smart card is sold as a means for accessing a subscription to a service. For example, a smart card is purchased that allows a six month subscription to an online version of a newspaper, such as the Wall Street Journal. The user is able to access each day's edition of the paper only when the smart card is inserted into a reader attached to the user's PC.

In a third embodiment of the invention, a model is provided whereby access to downloadable products is made available through the purchase of a smart card. For example, a user buys a new computer and a smart card is shipped with the computer which allows downloads of a pre-determined number of free software applications from an exclusive downloading site. In another example, a user purchases a smart card at a media store which allows a pre-determined number of downloads of music files from a site containing a large library of music files.

In a final embodiment of the invention, a card is provided which automatically customizes the Internet browser being used by the user, by providing a new “skin” and providing buttons on the face of the browser for access to specific sites. This is particularly useful for children in that it makes it easy for them to access specific sites on the Internet without typing cumbersome universal resource locators (URLs) and provides a certain amount of parental control by limiting the sites that the child can access. As an example of this, when a child inserts a card associated with a particular cartoon character into the reader, the Internet browser is launched having a skin decorated with images of the cartoon character and one or more buttons allowing access to various pages featuring that cartoon character.

The embodiments of the invention presented herein would all be implemented in the prior art through the use of a username/password combination which is provided to the user after the payment of a fee. The new models of the invention substitute the sale of a tangible item, namely the smart card, in place of the intangible username password combination.

In all models presented herein, the smart card must be present in a smart card reader attached to the user's PC while access is granted. Once the smart card is removed from the card reader, access is cut off. These models thereby provide several advantages over the prior art username/password combination. First, the physicality of the smart card associates a value with the smart card that is absent with the username/password model. Second, a username/password combination can be shared with other people without the loss of access for the original owner. The smart card is a tangible item that cannot be given to another person without a loss of access for the giver of the card. Therefore, the models presented herein help to reduce fraud through password sharing associated with the prior art methods of access. Lastly, a customized smart card can be retailed by the manufacturer and physically sold and advertised in stores, whereas the prior art username/password combination model does not provide such an opportunity.

We have presented several novel models wherein a salable, value-carrying tangible asset is used to provide access to online content.

### DESCRIPTION OF THE DRAWINGS

FIG. 1 is a system-wide view of components necessary to practice the invention or implement the models of the invention.

### DETAILED DESCRIPTION OF THE INVENTION

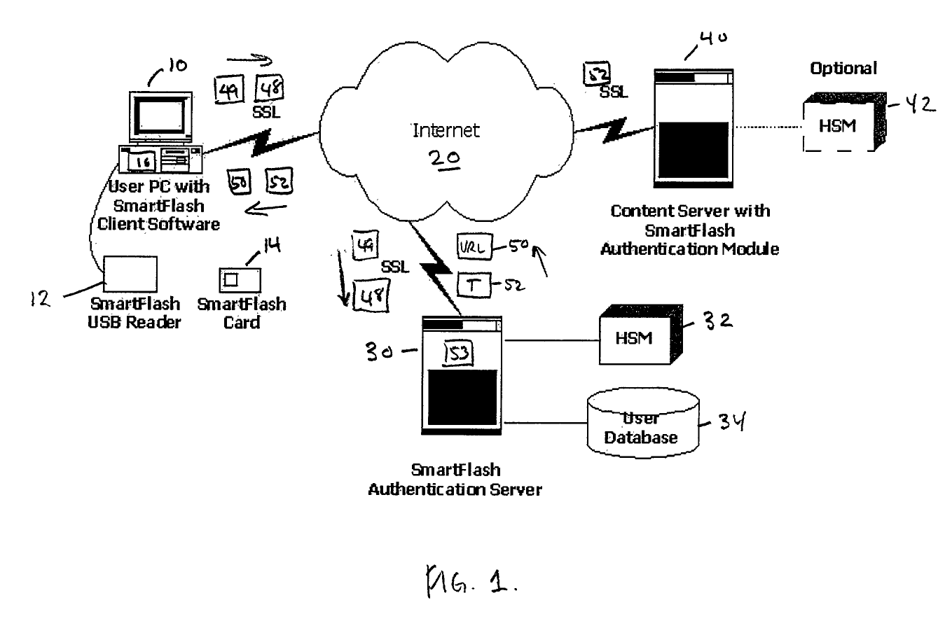

FIG. 1 shows an exemplary configuration on which the models of this invention could operate. At the center of the system is Internet 20. Connected to Internet 20 is user PC 10, having smart card reader 12 connected thereto and client software 16 running thereon. Smart card 14 is typically distributed by content providers by sale, promotional giveaway or via some other means. Smart card reader 12 and client software 16 may be distributed directly with smart card 14, or separately. Smart card 14 and smart card reader 12 may optionally be decorated with advertisements or logos related to the type of content being sold.

Content is served to users at user PC 10 from content server 40 over Internet 20. Also connected to Internet 20 is authentication server 30, having a database of users 34 and a hardware security module 32 attached thereto.

In operation, the user inserts smart card 14 into smart card reader 12 connected to user PC 10. Client software 16 detects the presence of smart card 14 in smart card reader 12 and initiates a application which causes an Internet browser to be started on user PC 10. User PC 10 then contacts authentication server 30 through Internet 20 A serial number 48 and an encrypted certificate 49 are sent to authentication server 30.

Authentication server 30 authenticates smart card 14 by running an encryption algorithm which takes as inputs serial number 48, encrypted certificate 49 and a master key 53, which is known only to authentication server 30. Hardware security module 32 assists authentication server 30 in verifying the authenticity of smart card 14. Hardware security module 32 may be, for example, an nForce™ Secure SSL Accelerator made by nCipher Inc. of Woburn, Mass., and assists authentication server 30 in the mathematically intense calculations needed to perform encryption and decryption.

Any one of many well known encryption algorithms could be used to verify the authenticity of smart card 14. For example, master key 53 and serial number 48 may be used to generate encrypted certificate 49, which is stored on smart card 14 along with serial number 48. When authentication server 30 receives serial number 48 and encrypted certificate 49, it can apply master key 53 to verify the identity of smart card 14.

Once smart card 14 is authenticated, authorization server 30 provides the URL 50 of content server 40 to user PC 10 through Internet 20. Additionally, an encrypted authentication ticket 52 is sent to user PC 10. Authentication ticket 52 is typically in the form of a cookie which is placed on user PC 10, and may be encrypted using any one of a number of well known private key encryption algorithms. Once user PC 10 has knowledge of URL 50, content server 40 is accessed via the browser running on user PC 10 in a manner which is well known in the art, and authentication ticket 52 is sent to content server 42. Authentication ticket 42 must be utilized to gain access to content server 42 within a predetermined, limited time of its creation, otherwise authentication ticket 42 may expire, in which case client software 16 will delete authentication ticket 52 from user PC 10. Additionally, authentication ticket 52 is only valid while smart card 14 is inserted into smart card reader 12. Should smart card 14 be removed from smart card reader 12, client software 16 will disconnect user PC 10 from content server 42 and delete authentication ticket 52 from user PC 10. Therefore, smart card 14 can only be used from one PC at any given time.

Content server 40 shared the private key used to encrypt authentication ticket 52 with authentication server 30. Therefore, content server 40 can decrypt authentication ticket 52. Once a valid decryption has occurred, content server 40 verifies that smart card 14 has the right to access the online content, and provides access to the user. Content server 40 may deny access for any one of a number of reasons. For example, the user's right to access the content may be on a subscription basis, wherein the subscription expires after a given period of time, after a predetermined number of accesses or after a predetermined amount of cumulative access time. Should any of these be exceeded, content server 40 may deny access. Alternatively, authentication server 30 may have knowledge of previous accesses using a particular smart card 14, and may deny authentication based on these criteria. However, this embodiment requires communication between content server 40 and authentication server 30 to share data regarding accesses using particular smart cards 40. It is also possible that authentication server 30 and content server 40 could be co-located or running on the same computer. Content server 40 may optionally have a hardware security module 42 to assist it in decrypting authentication tickets 52.

The novelty of this particular invention lies in the different models used for accessing content on content server 40. In the first and primary embodiment of the invention, access is granted to the content on content server 40, which is an exclusive website containing any type of content. In this model, content on the exclusive site served by content server 40 is provided to the user until the user dismisses the browser or removes smart card 14 from smart card reader 12. Alternatively, access to the exclusive site maybe withheld at the expiration of the encrypted authentication ticket 52 and, in certain circumstances, the provider of smart card 14 may wish to limit access of the holder of smart card 14 to a limited period of time or a limited cumulative period of time over several access attempts. In this case, the expiration of authentication ticket 52 would be set to the limit of the allowed accesses or the time remaining for access minus the access time already used in previous access attempts.

In an alternative embodiment of the invention, the access model is for a subscription service. Typically, in this model, content on content server 40 would be changed or updated periodically. In this model, authentication server 30 determines if the security data on smart card 14 is valid and, in addition, the number of times or the accumulated time that smart card 14 has previously accessed content server 40. If the security data on smart card 14 is valid, and the previous number of accesses or the accumulated access time is within the designated threshold, authentication server 30 provides URL 50 and encrypted authentication ticket 52 to user PC 10. Access is allowed by content server 40 until smart card 14 is withdrawn from smart card reader 12 or until encrypted authentication ticket 42 expires. In this model, it may be necessary for content server 40 to provide information to authentication server 30 regarding the total time that the user has accessed the system. Alternatively, this information can be stored directly on smart card 14.

In a third embodiment of the invention, smart card 14 provides access to a downloadable product stored on content server 40. Once content server 40 validates encrypted authentication ticket 52 and grants access, the user may download files containing downloadable content which can be in the form of files containing text, audio, video or application software. Once the user chooses to download a file, the file is transferred from content server 40 to user PC 10 via any standard Internet protocol for file transfer, such as FTP. In this model, it is necessary to keep track of the previous downloads of the user and, therefore, this information may be transferred from content server 40 authentication server 30 or the information may be stored directly on smart card 14. Access in this model may be limited, for example, to a pre-determined period of time or a pre-determined number of downloads.

In yet another embodiment of the invention, a customized Internet browser is provided to the user. The customized browser may be stored in the memory on smart card 14 and loaded each time smart card 14 is inserted into smart card reader 12. Alternatively, the customized browser may be installed from a CD-ROM as part of the install process whereby client software 16 is installed, or by downloading from the Internet. Once the security data on smart card 14 is authenticated by authentication server 30 and access is granted to content server 40 by means previously discussed, the user will have access to specialized sites via various buttons on the customized browser. Additionally, customized browser may be decorated with a specialized “skin” related to the content on content server 40. As in previous models, access to content server 40 is terminated when smart card 14 is withdrawn from smart card reader 12 or at the expiration of authentication ticket 52.

Several models have been presented for the use of a smart card for granting access to on-line content. The hardware used to describe these models is not meant to limit the scope of the invention, and other configurations are possible. For example, authentication server 30 and content server 40 may be combined into one machine. Additionally, other communications networks other than the Internet may be used to connect the content server with the user's PC. The actual scope of the invention is embodied in the claims which follow.

We claim:

1. A method for providing access to online content with a physical token comprising the steps of:
receiving requests for authentication of said physical tokens; and
providing an authentication ticket in response to said request;
wherein said authentication ticket can be used to access said online content

2. The method of claim 1 wherein said authentication ticket is only valid when used in conjunction with said physical token.

3. The method of claim 2 wherein said access is terminated if said physical token is removed.

4. The method of claim 3 wherein said authentication token is deleted when said physical token is removed.

5. The method of claim 1 wherein said authentication ticket is only valid for a limited time period.

6. The method of claim 1 wherein said physical token is a smart card.

7. The method of claim 3 wherein said authentication ticket provides access to an Internet web site.

8. The method of claim 3 wherein said online content changes over time and further wherein said authentication ticket provides access to a subscription to said online content.

9. The method of claim 8 wherein said access is limited by number of previous accesses.

10. The method of claim 8 wherein said access is limited by the cumulative time spent accessing said content.

11. The method of claim 8 wherein said access is limited by an expiration date associated with said physical token.

12. The method of claim 3 wherein said authentication ticket provides access to downloadable online content.

13. The method of claim 12 wherein said downloadable online content is selected from a group comprising text, graphics, audio, video, executable software and a combination of any of text, graphics, audio, video and executable software.

14. The method of claim 13 wherein said access is limited to a predetermined number of downloads.

15. The method of claim 13 wherein said access is limited to a predetermined period of time.

16. The method of claim 13 wherein said access is limited by criteria contained in said authentication ticket.

17. The method of claim 3 wherein said online content is accessed via a browser application.

18. The method of claim 17 wherein said browser application is customized for the online content being accessed.

19. The method of claim 18 wherein said customization includes one or more skins which are associated with said online content being accessed.

20. The method of claim 18 wherein said customization includes functional buttons for accessing various features of said online content.

21. The method of claim 3 wherein said authentication ticket is encrypted.

22. The method of claim 21 wherein said authentication ticket is encrypted with a private key.

23. The method of claim 22 wherein said physical token has a serial number and an encrypted certificate associated therewith and further wherein said step of providing an authentication ticket further comprises the steps of:
verifying the identity of said physical token by running an encryption algorithm which takes as inputs said serial number, said encrypted certificate and a master key;
verifying that access for said physical token has not expired; and
creating said authentication ticket using a private key associated with particular online content.

24. A method for providing access to online content with a physical token comprising the steps of:
receiving requests for authentication of said physical tokens; and
providing an authentication ticket in response to said request;
receiving requests for content, said requests being accompanied by said authentication ticket;
authenticating said authentication ticket; and
providing access to said online content.

25. The method of claim 24 wherein said online content is an internet web site.

26. The method of claim 25 wherein said online content is updated periodically and where said access to said online content is granted on a subscription basis.

27. The method of claim 26 wherein said online access is limited to an absolute time period.

28. The method of claim 26 wherein said online access is limited by the number of previous accesses.

29. The method of claim 26 wherein said number of previous accesses is tracked in a database associated with said physical token.

30. The method of claim 26 wherein said online access is limited by the cumulative time spent accessing said content.

31. The method of claim 26 wherein said cumulative time spent accessing said content is tracked in a database associated with said physical token.

32. The method of claim 25 wherein said step of providing access to said online content comprises allowing downloads from said internet web site.

33. The method of claim 32 wherein said downloads are selected from a group comprising text, graphics, audio, video, executable software and a combination of any of text, graphics, audio, video and executable software.

34. The method of claim 32 wherein said access is limited to a predetermined number of downloads.

35. The method of claim 32 wherein said access is limited to a predetermined period of time.

36. The method of claim 32 wherein said access is limited by criteria contained in said authentication ticket.

37. The method of claim 24 wherein said online content is accessed via a browser application.

38. The method of claim 37 wherein said browser application is customized for the online content being accessed.

39. The method of claim 38 wherein said customization includes one or more skins which are associated with said online content being accessed.

40. The method of claim 39 wherein said customization includes functional buttons for accessing various features of said online content.

41. The method of claim 24 wherein said authentication ticket is encrypted.

42. The method of claim 41 wherein said authentication ticket is encrypted with a private key.

43. The method of claim 42 wherein said physical token has associated with it a serial number and an encrypted certificate.

44. The method of claim 43 wherein said request for authentication includes said serial number and said encrypted certificate.

45. The method of claim 44 wherein said step of providing an authentication ticket further comprises the steps of:
verifying the identity of said physical token by running an encryption algorithm which takes as inputs said serial number, said encrypted certificate and a master key;
verifying that access for said physical token has not expired;
creating said authentication ticket using a private key associated with particular online content.

46. The method of claim 45 wherein said step of authenticating said authentication ticket comprises the step of decrypting said authentication ticket using said private key.

47. The method of claim 46 wherein said decrypted authentication ticket includes said serial number of said physical token and a date/time stamp.

48. The method of claim 47 wherein said authentication ticket is only valid for a limited time after its creation.

49. The method of claim 48 further comprising the step of verifying that said date/time stamp is within a predetermined elapsed period of time with respect to the current time.

50. A method for granting access to online content via a physical token comprising:
distributing said physical token, said physical token being associated with a specific content server and having authentication information stored thereon;
authenticating said physical token when inserted into a reader by a holder of said physical token;
providing said holder of said physical token a ticket for accessing said online content on said online server.

51. The method of claim 50 further comprising the steps of:
verifying said ticket; and
providing access to said online content.
